(19) United States
(12) Patent Application Publication
(10) Pub. No.: US 2004/0027605 A1
(43) Pub. Date: Feb. 12, 2004

(54) Fax machine with image display

(76) Inventor: Kevin M. Martin, Las Vegas, NV (US)

Correspondence Address: LITTMAN LAW OFFICES, LTD., P.O. BOX 15035 CRYSTAL CITY STATION, ARLINGTON, VA, 22215, US

(21) Appl. No.: 10/212,802

(22) Filed: Aug. 7, 2002

(51) Int. Cl. H04N 1/00; G06F 3/12; G06F 13/00

(52) U.S. Cl. 358/1.15; 358/442; 358/400

(57) ABSTRACT

A fax machine with an image display includes a housing, a handset, a power line, and a telephone line. The fax machine also includes a central processing unit, read only memory, random access memory, a speaker, a fax machine interface, a fax machine image display, a network interface, a modem interface, a detector, and a hook switch. The fax machine receives power input through the fax machine interface. The fax machine interface interconnects the image processing section, the operation display section, the operation control section, and the operation storage section with a control bus line. The image processing section is interconnected with a scanner and a printer. The scanner is configured to scan original fax input data. Fax input data may be a document, photograph, or an electronic data file. The printer is configured to print out fax output data on a hard copy.

### BACKGROUND OF THE INVENTION

1. Field of the Invention

The present invention relates generally to facsimile (fax) machines and, more particularly, to fax machines with plural options.

2. Description of the Related Art

The fax machine was invented in 1842 by Alexander Bain. Many improvements were made to Bain's device in the following half century, including the synchronization of the transmitter and receiver and the use of a photoelectric cell for transmitting photos. In 1924 the first wire photo was sent from Cleveland to New York. The use of fax machines began to spread rapidly. Fax machines are now widely used in personal and professional workplaces. Modern fax machines typically include a wide variety of options, such as automatically redialing a phone number if the number is busy, storing an incoming fax message into memory if the fax printer is actively printing a previously received fax message, etc. However, currently there are no fax machines that provide the ability for users to review and/or delete received fax messages prior to having them printed.

The related art is represented by the following references of interest.

U.S. Pat. No. 5,796,494, issued on Aug. 18, 1998 to Yuji Asano, describes a fax machine connectable to an external computer. Asano does not suggest a fax machine with an image display according to the claimed invention.

U.S. Pat. No. 6,011,905, issued on Jan. 4, 2000 to Daniel P. Huttenlocher et al., describes structured document representations suitable for rendering into printable or displayable document raster images. Huttenlocher et al. does not suggest a fax machine with an image display according to the claimed invention.

U.S. Pat. No. 6,043,903, issued on Mar. 28, 2000 to Kiyomoto Nakai et al., describes a fax machine wherein when a call is received, a user can recognize the caller prior to answering the incoming call and the user can decide whether or not to answer the incoming call in consideration of the caller, and the user can be informed of incoming-call journal data relating to at least a call to which no answer was made. Nakai et al. does not suggest a fax machine with an image display according to the claimed invention.

U.S. Pat. No. 6,157,464, issued on Dec. 5, 2000 to Mark C. Bloomfield et al., describes fax store and forward facilities. Bloomfield et al. does not suggest a fax machine with an image display according to the claimed invention.

U.S. Pat. No. 6,166,830, issued on Dec. 26, 2000 to Chuong S. Koh et al., describes an integrated scan-to-store apparatus that allows images to be scanned and stored on a removable data/storage device. Koh et al. does not suggest a fax machine with an image display according to the claimed invention.

U.S. Pat. No. 6,188,766 B1, issued on Feb. 13, 2001 to Paul C. Kocher, describes an apparatus and method for confirming, timestamping, and archiving documents using fax machines. Kocher does not suggest a fax machine with an image display according to the claimed invention.

U.S. Pat. No. 6,281,988 B1, issued on Aug. 28, 2001 to Nikolai K. N. Leung, describes an apparatus and method for supporting analog fax calls between two wireless subscriber stations in a tandem configuration. Leung does not suggest a fax machine with an image display according to the claimed invention.

U.S. Pat. No. 6,288,797 B1, issued on Sep. 11, 2001 to Sueo Ueno, describes an image density correction device for correcting an image density difference in an image read from an original document by a photoelectric converting element, an image reading device using the photoelectric converting element, and an image forming apparatus. Ueno does not suggest a fax machine with an image display according to the claimed invention.

U.S. Pat. No. 6,297,885 B1, issued on Oct. 2, 2001 to Atsushi Murakami, describes an image input-output apparatus which is capable of detecting the width of a recording paper without using a separate sensor specially designed to that purpose. Murakami does not suggest a fax machine with an image display according to the claimed invention.

U.S. Pat. No. 6,310,942 B1, issued on Oct. 30, 2001 to Joseph E. Bashoura et al., describes a fax routing system and method using a standard fax machine and a personal computer. Bashoura et al. does not suggest a fax machine with an image display according to the claimed invention.

U.S. Pat. No. 6,323,962 B1, issued on Nov. 27, 2001 to Shingo Itoh, describes a fax machine which does not fail to receive fax data transmitted from a different fax-data transmitter even if the fax machine is not permitted to transmit the fax data to a computer connected to the fax machine. Itoh does not suggest a fax machine with an image display according to the claimed invention.

U.S. Pat. No. 6,330,079 B1, issued on Dec. 11, 2001 to Andrew J. Dugan et al., describes a platform for use in a communications system that integrates voicemail and faxmail functionality. Dugan et al. does not suggest a fax machine with an image display according to the claimed invention.

U.S. Pat. No. 6,348,970 B1, issued on Feb. 19, 2002 to Adam N. Marx, describes an apparatus and method for interfacing a fax machine with a computer network. Marx does not suggest a fax machine with an image display according to the claimed invention.

U.S. Pat. No. 6,378,598 B1, issued on Apr. 16, 2002 to Noriko Matsumoto et al., describes a fax machine for use in combination with a personal computer. Matsumoto et al. does not suggest a fax machine with an image display according to the claimed invention.

Germany Patent document DE 42 29 349 A1, published on Sep. 22, 1994, describes a switching device for the direct connection of a personal computer and a fax machine. Germany '349 does not suggest a fax machine with an image display according to the claimed invention.

International Patent document WO 01/74052 A2, published on Mar. 9, 2001, describes a machine and method for imaging digital camera output on a standard light lens copier, the camera having a reflective flush with the camera so that the display can lay flat on the copier platen without interference from any other portion of the camera. International '052 does not suggest a fax machine with an image display according to the claimed invention.

International Patent document WO 01/86939 A1, published on Nov. 15, 2001, describes a digital network interface for analog fax equipment. International '939 does not suggest a fax machine with an image display according to the claimed invention.

None of the above inventions and patents, taken either singularly or in combination, is seen to describe the instant invention as claimed.

### SUMMARY OF THE INVENTION

The present invention is a fax machine with an image display. The fax machine includes a housing, a handset, a power line, and a telephone line. The fax machine also includes a central processing unit (CPU), read only memory (ROM), random access memory (RAM), a speaker, a fax machine interface, a fax machine image display, a network interface, a modem interface, a detector, and a hook switch. The fax machine receives power input through the fax machine interface. The power input may be conventional utility power, such as 120 VAC or the like. The fax machine interface interconnects the image processing section, the operation display section, the operation control section, and the operation storage section with a control bus line. The image processing section is interconnected with a scanner and a printer. The scanner is configured to scan original fax input data. Fax input data may be a document, photograph, or an electronic data file. The printer is configured to print out fax output data on a hard copy.

The CPU may be any known microprocessing integrated circuit. The ROM stores software code for the fax machine operation. Such software code includes the fax machine operating system which contains software code to successfully operate all elements of the fax machine described above. The CPU operates under the control of the fax machine operating system to control the operations of the fax machine. The CPU controls the fax machine either directly or indirectly via a control bus.

The CPU controls the fax machine by communicating in a well known manner with the ROM, the RAM, the speaker, the fax machine interface, the image processing section, the scanner, the printer, the operation display section, the operation control section, the operation storage section, the fax machine image display, the network interface, the modem interface, the modem, the hook switch, the detector, and the line controller.

The ROM contains the fax machine operating system software code, or programs utilized by the CPU to perform the standard facsimile functions as well as the fax image display feature of the present invention. The RAM contains memory for storing system parameters and encoded communication data and line buffers for passing unencoded data.

The image processing section interconnects the fax machine interface with the scanner and the printer. The fax input data is transmitted from the fax machine in a standard manner. The scanner senses image data from the fax input to be transmitted and converts it to analog signals. The image processing section converts these analog fax signals to digital fax data. These data are processed through the fax machine interface, where they are passed to the CPU via a RAM buffer. The CPU then sends the data to the network interface and/or the modem interface, where they are sent to external network devices and/or the telephone line.

The fax machine generates a hard copy of received fax data, e.g. fax messages, using the printer, in a well known manner as briefly described hereinafter. The network interface and/or the modem couples fax data over an external network device and/or the telephone line. The printer is used to print fax messages or images on a paper medium. These images result from fax data which arrives over an external network and/or the telephone line. In a well known manner, this fax data is coupled through the network interface and/or the modem, demodulated by the modem, passed through the RAM, decoded by the CPU, stored in a RAM buffer memory, and sent to the printer for printing. An external printer may be connected via an input/output interface to the fax machine.

The operation display section includes one or more screens of any known type, such as liquid crystal screens or the like, to provide operational messages to a user pertaining to the operation of the fax machine. For example, operation display section may visually output the date, the time, a phone number being dialed, an error message, or the like, on the operation display screen. The operation display section also includes keypad buttons and one or more function buttons, such as, illustratively, send, stop, copy, and repertory dial buttons. Activation of these function buttons and keypad buttons enables the user to enter input commands or requests to the CPU. The operation display section may also include one or more light emitting diodes (LEDs) to display various features or machine status.

Output messages may also be communicated through audible or voice messages transmitted through a speaker or a telephone handset. The fax machine may include machine sensors, such as photointerrupt sensors, reflective photosensors, switches, or the like, which may detect the position of an original fax input document, fax paper, a paper cutter, and fax machine covers and which, depending on their state, can indicate error conditions such as original document jam, thermal copy jams, paper cutter jams or cover-open condition.

The operation control section causes the CPU to execute software code that may cause the operation display section to visually output the date, the time, a phone number being dialed, an error message, or the like, on the operation display screen.

The operation storage section is configured to store incoming and/or outgoing fax data. The operation storage section may be configured in the form of a hard disk drive, a floppy disk drive, or the like, according to the desires of the user

The fax image display may be any known type of display, such as an LCD display or the like. The fax image display may also include a touch screen. The fax machine operating system software includes software code configured to enable the fax machine to store all incoming/outgoing fax data until one is selected for viewing. The user may readily interact with the fax image display screen in any known manner to select a stored fax for viewing, to print a stored fax, to delete a stored fax, to archive a stored fax, or any combination thereof. All incoming/outgoing fax data can be archived in RAM initially and then may be stored in the operation storage section on a suitable computer readable medium, such as a floppy disk, a CD disk, or the like. This data may then be searched and viewed on an external computer. The fax machine operating system enables the user to easily delete unsolicited incoming fax data (“junk” mail) without wasting ink and paper. The fax machine operating system may also enable the user to block future incoming fax data from that particular telephone number. The fax machine operating system software can recognize any known image files, such as JPEG, GIF, TIFF, BMP, DXF, VSD, AI, DWG, or the like.

The modem interface interconnects the modem with the control bus line. The modem may include one or more modems that may be internal modems or external modems according to the desires of the user. The modem may be interconnected with the telephone line and a line controller. The detector detects whether the hook switch is in an on-hook condition or an off-hook condition. If the hook switch is in an on-hook condition, the detector remains inactive and the line controller does nothing unless incoming fax data is being received, in which case the line controller activates the modem and causes incoming fax data to be received. If hook switch is in an off hook condition.

Accordingly, it is a principal aspect of the invention to provide a fax machine with an image display that includes a central processing unit, read only memory, random access memory, a speaker, a fax machine interface, a fax machine image display, a network interface, a modem interface, a hook switch detector, and a hook switch.

It is another aspect of the invention to provide a fax machine with an image display that includes a central processing unit, read only memory, random access memory, a speaker, a fax machine interface, a fax machine image display, a network interface, a modem interface, a hook switch detector, and a hook switch

It is a further aspect of the invention to provide a fax machine with an image display that includes a central processing unit, read only memory, random access memory, a speaker, a fax machine interface, an image processing section, a scanner, a printer, an operation display section, an operation control section, and the operation storage section, a fax machine image display, a network interface, a modem interface, a hook switch detector, and a hook switch, wherein the image processing section interconnects the scanner and the printer with the fax machine interface

Still another aspect of the invention is to provide a fax machine with an image display that includes a central processing unit, read only memory, random access memory, a speaker, a fax machine interface, a fax machine image display, a network interface, a modem interface, a hook switch detector, and a hook switch, wherein the read only memory includes software code for storing all incoming or outgoing fax data until one is selected for viewing, and software code for printing stored fax data, deleting stored fax data, archiving stored fax data, or any combination thereof.

It is an aspect of the invention to provide improved elements and arrangements thereof in a fax machine with an image display for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a front, environmental view of a fax machine with an image display according to the present invention.

FIG. 2 is a block diagram of a fax machine with an image display according to the present invention.

Similar reference characters denote corresponding features consistently throughout the attached drawings.

### DETAILED DESCRIPTION OF THE PREFERRED EMBODIMENTS

The present invention is a fax machine with an image display. The invention disclosed herein is, of course, susceptible of embodiment in many different forms. Shown in the drawings and described hereinbelow in detail is are preferred embodiments of the invention. It is to be understood, however, that the present disclosure is an exemplification of the principles of the invention and does not limit the invention to the illustrated embodiments.

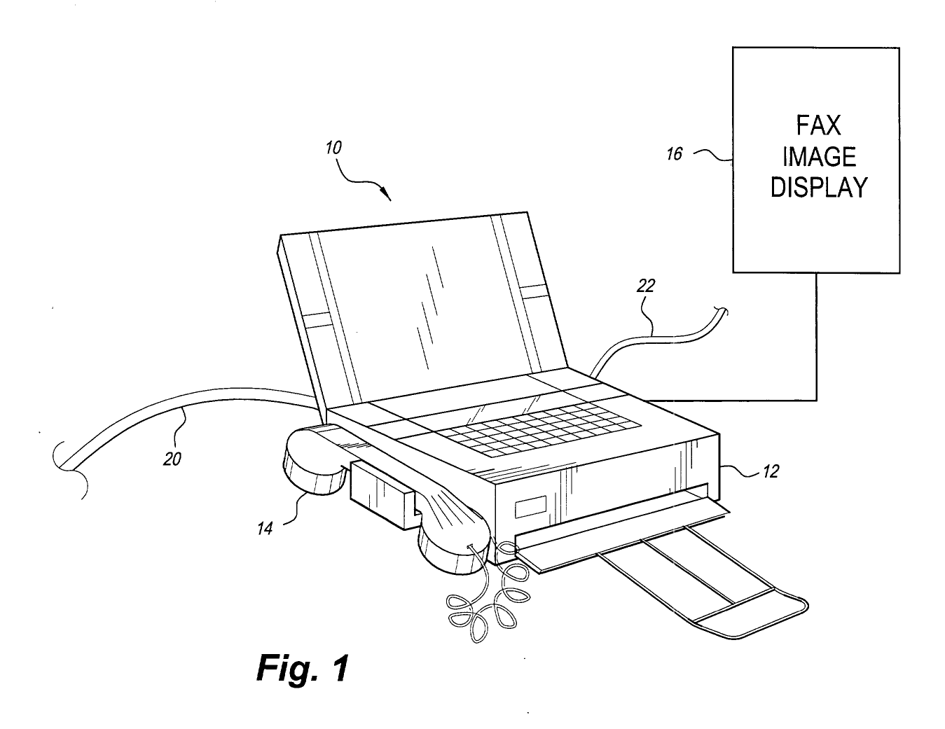

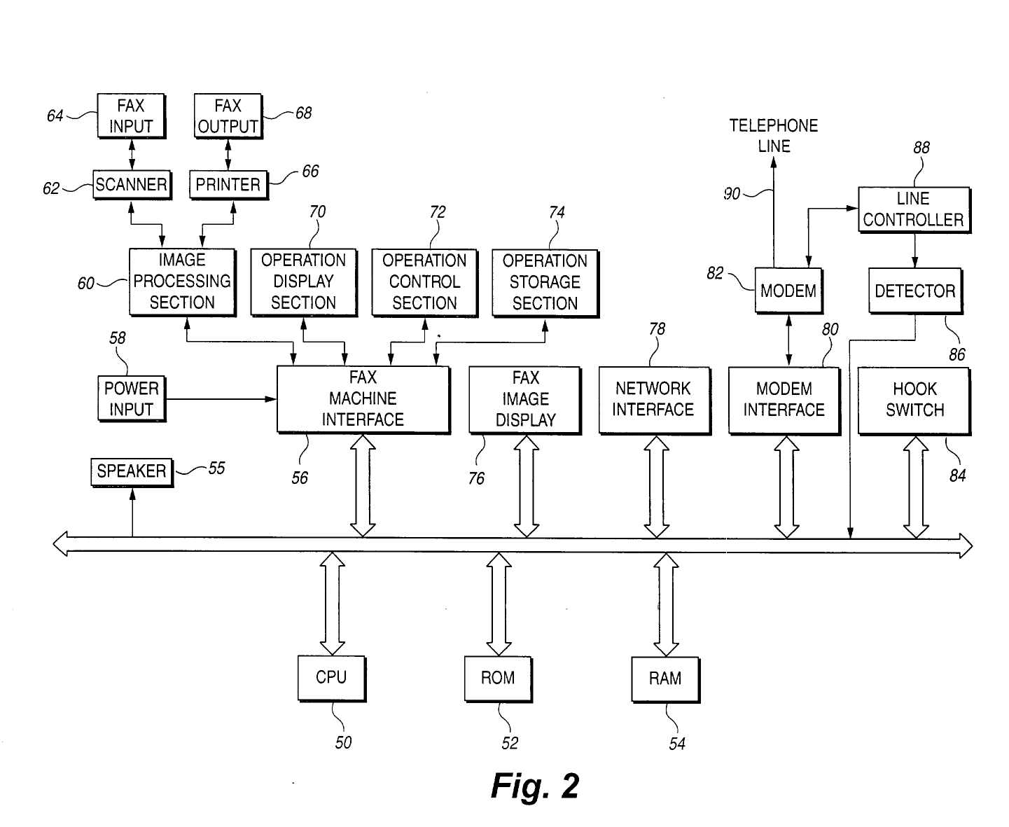

Referring to the drawings, FIG. 1 illustrates a fax machine 10 with an image display 16 according to the invention. Fax machine 10 includes a housing 12, a handset 14, a power line 20, and a telephone line 22. As shown in FIG. 2, the fax machine includes CPU 50, ROM 52, RAM 54, speaker 55, fax machine interface 56, fax machine image display 76, network interface 78, modem interface 80, detector 86, and hook switch 84. The fax machine receives power input 58 through fax machine interface 56. Power input 58 may be conventional utility power, such as 120 VAC or the like. Fax machine interface 56 interconnects image processing section 60, operation display section 70, operation control section 72, and operation storage section with a control bus line. Image processing section 60 is interconnected with a scanner 62 and a printer 66. Scanner 64 is configured to scan original fax input data 64. Fax input data 64 may be a document, photograph, or an electronic data file. Printer 66 is configured to print out fax output data 68 on a hard copy.

CPU 50 may be any known microprocessing integrated circuit. ROM 52 stores software code for the fax machine operation. Such software code includes the fax machine operating system which contains software code to successfully operate all elements of the fax machine described above. CPU 50 operates under the control of the fax machine operating system to control the operations of the fax machine. CPU 50 controls the fax machine either directly or indirectly via a control bus.

CPU 50 controls the fax machine by communicating in a well known manner with ROM 52, RAM 54, speaker 55, fax machine interface 56, image processing section 60, scanner 62, printer 66, operation display section 70, operation control section 72, operation storage section 74, fax machine image display 76, network interface 78, modem interface 80, modem 82, hook switch 84, detector 86, and line controller 88.

ROM 52 contains the fax machine operating system software code, or programs utilized by CPU 50 to perform the standard facsimile functions as well as the fax image display feature of the present invention. RAM 54 contains memory for storing system parameters and encoded communication data and line buffers for passing unencoded data.

Image processing section 60 interconnects fax machine interface 56 with scanner 62 and printer 66. Fax input data 64 is transmitted from the fax machine in the standard manner. Scanner 62 senses image data from the fax input 64 to be transmitted and converts it to analog signals. Image processing section 60 converts these analog fax signals to digital fax data. These data are processed through fax machine interface 56, where they are passed to CPU 50 via a RAM 54 buffer. CPU 50 then sends the data to network interface 78 and/or modem interface 80, where they are sent to external network devices and/or telephone line 90.

The fax machine generates a hard copy of received fax data, e.g. fax messages, using printer 66, in a well known manner as briefly described hereinafter. The network interface 87 and/or modem 82 couples fax data over external network device and/or telephone line 90. Printer 66 is used to print fax messages or images on a paper medium. These images result from fax data which arrives over an external network and/or telephone line 90. In a well known manner, this fax data is coupled through network interface 78 and/or modem 82, demodulated by modem 82, passed through RAM 54, decoded by CPU 50, stored in a RAM 54 buffer memory, and sent to printer 66 for printing. An external printer (not shown) may be connected via an input/output interface to the fax machine.

Operation display section 70 includes one or more screens of any known type, such as liquid crystal screens or the like, to provide operational messages to a user pertaining to the operation of the fax machine. For example, operation display section 70 may visually output the date, the time, a phone number being dialed, an error message, or the like, on the operation display screen. Operation display section 70 also includes keypad buttons and one or more function buttons, such as, illustratively, send, stop, copy, and repertory dial buttons. Activation of these function buttons and keypad buttons enables the user to enter input commands or requests to CPU 50. Operation display section 70 may also include one or more light emitting diodes (LEDs) to display various features or machine status.

Output messages can also be communicated through audible or voice messages transmitted through a speaker 55 or a telephone telephone 14 (see FIG. 1). The fax machine may include machine sensors, such as photointerrupt sensors, reflective photosensors, switches, or the like, which may detect the position of an original fax input document, fax paper, a paper cutter, and fax machine covers and which, depending on their state, can indicate error conditions such as original document jam, thermal copy jams, paper cutter jams or cover-open condition.

Operation control section 72 causes CPU to execute software code that causes operation display section 70 may visually output the date, the time, a phone number being dialed, an error message, or the like, on the operation display screen.

Operation storage section 74 is configured to store incoming and/or outgoing fax data. Operation storage section 74 may be configured in the form of a hard disk drive, a floppy disk drive, or the like, according to the desires of the user.

Fax image display 76 may be any known type of display, such as an LCD display or the like. Fax image display 76 may also include a touch screen. The fax machine operating system software includes software code configured to enable the fax machine to store all incoming/outgoing fax data until one is selected for viewing. The user may readily interact with the fax image display screen in any known manner to select a stored fax for viewing, to print a stored fax, to delete a stored fax, to archive a stored fax, or any combination thereof.

All incoming/outgoing fax data can be archived in RAM 54 initially and then may be stored in the operation storage section on a suitable computer readable medium, such as a floppy disk, a CD disk, or the like. This data may then be searched and viewed on an external computer. The fax machine operating system enables the user to easily delete unsolicited incoming fax data (“junk” mail) without wasting ink and paper. The fax machine operating system may also enable the user to block future incoming fax data from that particular telephone number. The fax machine operating system software can recognize any known image files, such as JPEG, GIF, TIFF, BMP, DXF, VSD, AI, DWG, and the like.

Network interface 78 is configured to interconnect CPU 50 with external network devices. The fax machine operating system enables the fax machine to be linked to external network devices, and to notify interconnected parties that fax data for a certain entity/telephone number has arrived. Then the fax data can be viewed on that user's computer.

Modem interface 80 interconnects modem 82 with the control bus line. Modem 82 may include one or more modems that may be internal modems or external modems according to the desires of the user. Modem 82 may be interconnected with a telephone line 90 and a line controller 88. Detector 86 detects whether hook switch is in an on-hook condition or an off-hook condition. If hook switch 84 is in an on-hook condition, detector 86 remains inactive and line controller 88 does nothing unless incoming fax data is being received, in which case line controller activates modem 82 and causes incoming fax data to be received. If hook switch 84 is in an off hook condition, line controller 88 seizes an open telephone line 90 and causes an outgoing fax message to be transmitted from the fax machine.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A fax machine with an image display, the fax machine comprising:
a central processing unit;
read only memory;
random access memory;
a speaker;
a fax machine interface;
a fax machine image display;
a network interface;
a modem interface;
a hook switch detector; and
a hook switch.

2. The fax machine according to claim 1, wherein the fax machine receives power input through the fax machine interface.

3. The fax machine according to claim 1, wherein the fax further comprising an image processing section, a scanner, a printer, an operation display section, an operation control section, and the operation storage section, wherein the image processing section interconnects the scanner and the printer with the fax machine interface.

4. The fax machine according to claim 1, wherein the read only memory stores a fax machine operating system software code for the fax machine operation.

5. The fax machine according to claim 4, wherein the fax machine operating system software code includes software code for storing all incoming or outgoing fax data until one is selected for viewing.

6. The fax machine according to claim 4, wherein the fax machine operating system software code includes software code for printing stored fax data, deleting stored fax data, archiving stored fax data, or any combination thereof.

7. The fax machine according to claim 4, wherein the operation display section includes at least one liquid crystal display.
